(19) United States
(12) Patent Application Publication
(10) Pub. No.: US 2020/0253109 A1
(43) Pub. Date: Aug. 13, 2020

(54) SEED METERING DISC

(71) Applicant: Larry Hak, Convoy, OH (US)

(72) Inventor: Larry Hak, Convoy, OH (US)

(21) Appl. No.: 16/784,856

(22) Filed: Feb. 7, 2020

Related U.S. Application Data
(60) Provisional application No. 62/802,767, filed on Feb. 8, 2019.

(51) Int. Cl. A01C 7/12; A01C 7/04

(52) U.S. Cl. CPC A01C 7/128; A01C 7/121; A01C 7/046

(57) ABSTRACT

An exemplary seed metering system includes a seed meter and a metering disc. The metering disc has one or more pockets, and each pocket has one or more openings. The pockets are configured to receive at least two different seed types.

### CROSS-REFERENCE TO RELATED APPLICATIONS

This application claims the benefit of U.S. Provisional Patent Application No. 62/802,767, filed Feb. 8, 2019, and entitled SEED METERING DISC (Attorney Docket 27639/04004), the entire disclosure of which is hereby incorporated herein by reference in its entirety.

### TECHNICAL FIELD

The present invention relates generally to seed metering systems, and in particular to vacuum seed meters.

### BACKGROUND OF THE INVENTION

Seed metering systems, such as brush-type, finger pickup, and vacuum seed meters, distribute seeds at predetermined intervals during the planting of a field. Prior seed metering discs are disclosed in U.S. Pat. Nos. 6,634,522 and 7,083,067 filed on Sep. 14, 2001 and entitled Universal Seed Metering Disc.

### SUMMARY

Exemplary embodiments of seed metering systems and seed metering discs capable of dispensing a variety of seed types are disclosed herein.

In one exemplary embodiment, a seed metering system comprises a seed meter and a metering disc. The metering disc has one or more pockets, and each pocket has one or more openings. The pockets are configured to receive at least two different seed types.

An advantage of the present invention is that seeds of varying sizes and types may be planted by one metering disc or one set of metering discs. Still further advantages of the present invention will become apparent to those of ordinary skill in the art upon reading and understanding the following detailed description of embodiments of the present invention.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a front view of an exemplary seed metering system;

FIG. 2 is a back view of an exemplary seed metering system;

FIG. 3 is a front view of an exemplary seed metering disc; and

FIG. 4 is a cross-sectional view of the seed metering disc of FIG. 3 taken along the line 4-4.

### DETAILED DESCRIPTION

The following description refers to the accompanying drawings, which illustrate specific embodiments of the present disclosure.

Other embodiments having different structures and operation do not depart from the scope of the present disclosure.

Exemplary embodiments of the present disclosure are directed to seed metering discs for discharging seeds from a seed metering system. It should be noted that various embodiments of seed metering discs are disclosed herein, and any combination of these options can be made unless specifically excluded. In other words, individual components or portions of the disclosed mounts can be combined unless mutually exclusive or otherwise physically impossible.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of).

In many agricultural areas, large planters equipped with numerous row units are used to plant crop fields. The row units follow the planter and discharge seeds into the soil at a selected distribution determined by the type of seed being planted. To ensure uniformity and proper distribution throughout the field, seed meters are attached to the row units. Seed meters discharge seeds at a rate determined by the speed of the planter and the desired spacing of the seeds.

Large seed reservoirs store the seeds as the planters move across the crop fields. Seeds are released from the seed reservoirs and are evenly dispersed between the row units. The seeds travel down the row unit and are discharged into a seed meter. Seed meters typically employ rotating discs with pockets or channels to pick up seeds from the inlet of the seed meter to be discharged onto the ground through a seed tube. Various brushes, spring loaded fingers, vacuum pressure, and/or any other suitable means are employed to retain seeds in the pockets or channels of the disc as it rotates through the meter.

A seed metering disc is typically rotated in a substantially vertical plane. Seeds enter the meter and are picked up by the disc near the bottom of the rotation and are released after approximately three quarters of a rotation such that they travel vertically downwards toward the ground. In other words, in a clockwise rotating disc, the seeds are picked up at the 6 o'clock position and are released near the 3 o'clock position. The rotational speed of the disc determines the rate at which seeds are distributed, and the rotational speed of the disc can be varied based on the changing speed of the row unit over the ground. For example, to maintain uniform spacing of seeds during a turn, seed meters in row units toward the outside of the turn will need to distribute seeds more frequently than those on row units near the inside of the turn. The rotational speed of the disc can also be varied for different types of seeds. In some seed meters, a gear box may be used with different seed metering discs to vary the rotational speed of the disc for different seed types.

In a vacuum seed meter the seed metering disc includes one or more vacuum openings in each of its one or more pockets. A vacuum pump is used to generate a low pressure region on a portion of a back side of the disc. The vacuum openings in each of the one or more pockets of the disc are in fluid communication with this low pressure region, thereby creating a pressure differential from the front side to the back side of the disc. Seeds in the pockets of the disc are held in the pockets by a retention force that results from the difference in pressure between the front and back sides of the disc. As the disc rotates, pockets move in and out of the low pressure region so that the retention force holds seeds in a pocket for only a portion of a full rotation of the disc. When a pocket moves out of the low pressure region, the reduced retention force, which, in some embodiments may go to zero, allows the seed or seeds in that pocket to be released from the disc. The location of this release can be altered in different embodiments, for example, by changing the location and/or shape of the end of the low pressure region, to determine a seed trajectory as the seed is discharged into a seed tube, and ultimately lands on the ground.

In some crops, seeds will germinate and grow best if they are planted one at a time and spaced apart in the soil. The process of distributing one seed at a time from a large quantity of seeds is called singulation. When distributing seeds one at a time, pockets and vacuum openings in the seed disc are typically sized to retain a single seed type of a particular size and deliver it to the soil at a fixed point in the rotation of the seed disc. See, e.g., U.S. Pat. Nos. 5,058,766; 6,634,522. Due to the design of the pockets and vacuum openings, seed metering discs will only distribute seeds properly if the seeds are of the size the seed discs are designed to handle. Therefore, when planting more than one type of crop, and thus using different seed sizes, more than one set of seed metering discs must be purchased and alternatively installed to allow for proper seed metering during singulation. Using mismatched seed discs and seeds may cause some pockets to not pickup seeds, or cause seeds to slip from the seed pockets at various points during seed disc rotation.

When planting other crops, particularly those with smaller seeds, seeds do not need to be singulated, but are spread out evenly over a given area. For example, some seeds may grow best when about 4 pounds of seeds are planted per acre of land, while others may grow properly when about 150 pounds of seeds are planted per acre. Varying sizes of the seeds can further contribute to this variation. Seeds may range in quantity from about 1,800 seeds per pound up to about 1,300,000 seeds per pound. In some situations, a mixture of seeds is planted, such as, for example, when planting cover crops. When planting a mixture of seeds, the seed meter must be capable of distributing the mixture evenly, so that the mixture of seed types or sizes is not significantly different from the inlet of the meter to the outlet of the meter. In other words, a seed meter used with a mix of seeds should distribute seeds in the same proportion as they were found in the bulk mixture. An exemplary seed metering disc as described below may be used with a variety of seeds, each having different sizes, and with mixtures of seeds.

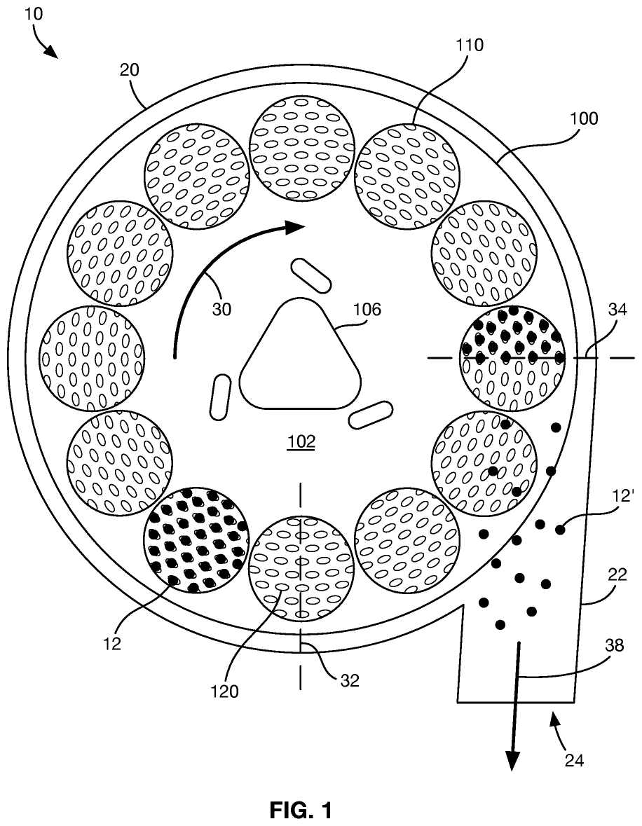

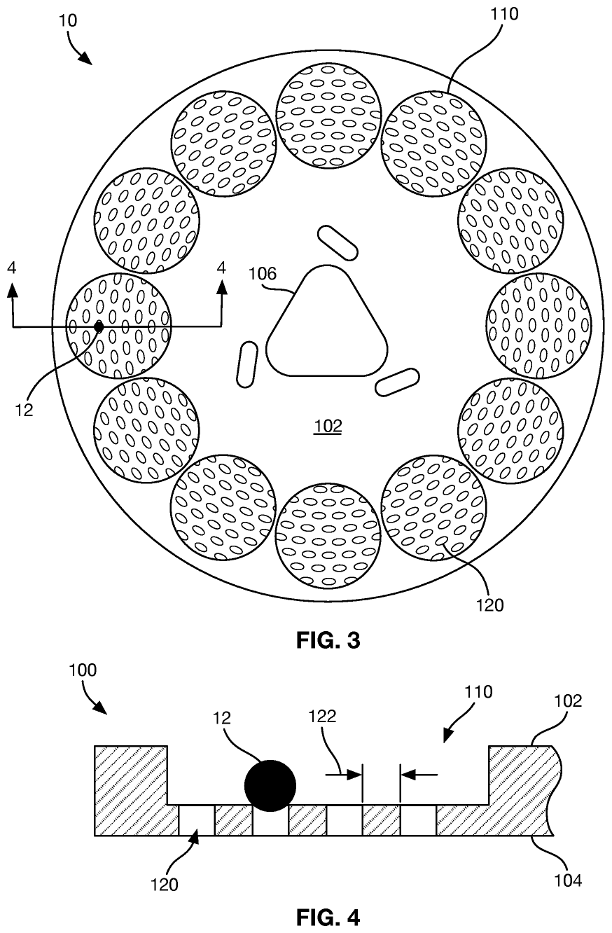

Turning now to FIGS. 1-4, an exemplary embodiment of a vacuum seed meter 10 and seed metering disc 100 are shown. The seed meter 10 includes a housing 20 that has an inlet opening (not shown) that allows seeds 12 to enter the meter 10. A seed chute 22 extends from the housing 20 to an outlet opening 24 from which seeds 12′ are discharged.

The seed metering disc 100 has a front side 102 and a back side 104. A plurality of seed pockets 110 are disposed in the front side 102 of the disc 100 proximate the perimeter. Seeds 12 enter the meter 10 at the inlet opening and are carried through the meter 10 in the pockets 110 of the disc 100 until being discharged into the seed chute 22 and out of the outlet opening 24. Each pocket 110 includes one or more vacuum openings 120 that are in fluid communication with the pockets 110 on the front side 102 and the back side 104 of the disc 100. The width, depth, and shape of each seed pocket 110, and the size, shape, spacing, and number of vacuum openings 120 in each pocket are selected to accommodate a range of seeds having different shapes and sizes. In certain embodiments, the vacuum openings 120 have a diameter of between about 0.001 inches and about 0.500 inches, or between about 0.010 and 0.100 inches.

A mounting portion 106 of the seed metering disc 100 is rotatably assembled to the housing 20. The disc 100 may be rotatably assembled to the housing 20 in any way, such as, for example, with an axle, an annular groove, ball bearings, air bearings, or any other means of allowing the disc 100 to rotate within the housing 20. The mounting portion 106 can be configured for use in various vacuum seed meters, such as, for example, a Kinze Manufacturing 4000 series vacuum seed meter, a John Deere Pro-Series vacuum seed meter, a Precision Planting seed meter, or the like. Exemplary seed metering discs made for seed meters of other manufacturers may vary in diameter, pocket position, thickness, and/or include other features to operate properly within different seed meters. Exemplary seed metering discs are also suitable for use with a variety of seeds, such as, for example, clover, sorghum, wheat, oats, rice, sesame seeds, sunflower, canola, hairy vetch, sun hemp, triticale, rye grasses, radish, corn, rye, cereal rye, teff grass, mil, wheat, oats, canola, flax, cow peas, and the like.

A motor (not shown) or other device rotates the disc 100 in the direction indicated by arrow 30, that is, in the clockwise direction when facing the front side 102 of the disc 100. The motor can rotate the disc 100 by rotating the mounting portion 106, engaging a track or gear teeth on one or both sides 102, 104 of the disc 100, or by engaging the outer diameter of the disc 100 in some way, such as, for example, via a gear or belt. The disc 100 is rotated in a substantially vertical plane in the illustrated embodiment and can be rotated in another orientation and/or direction in a different seed meter.

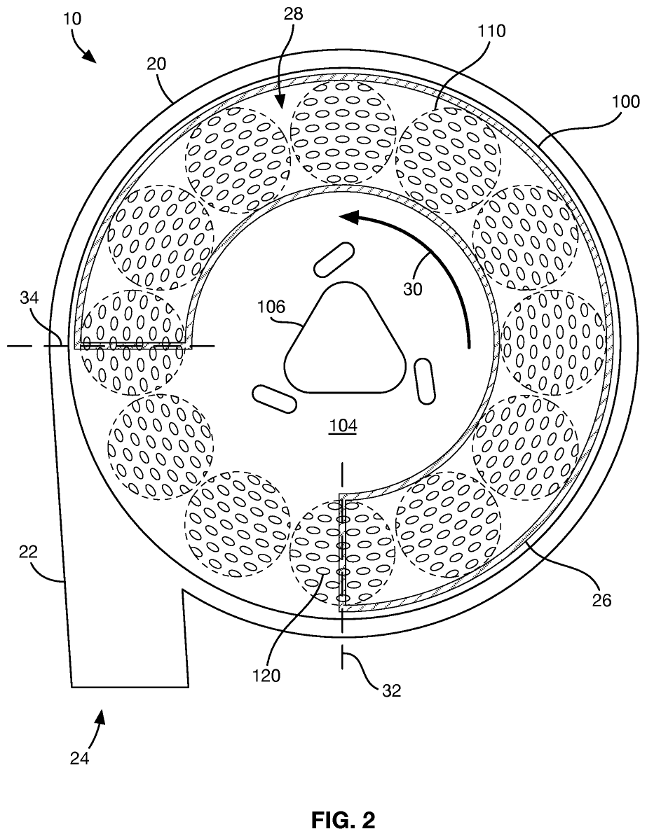

A seal member 20 of the housing 20 engages the back side 104 of the disc 100. The seal member 20 surrounds a low-pressure region 28 on the back side 104 of the disc 100. The air pressure in the low-pressure region 28 is reduced from atmospheric pressure, for example, by using a vacuum pump (not shown) connected to the seed meter 100. The seal member 26 contacts the back side 104 of the disc 100 to form a seal between the low-pressure region 26 and the interior of the housing 20 which is generally at atmospheric pressure. The low-pressure region 28 extends angularly from a pickup location 32 to a release location 34. During operation of the seed meter 10, the disc 100 rotates while the seal member 26 remains stationary so that the pickup and release locations 32, 34 remain fixed relative to the housing 20 of the seed meter 10. As shown in FIG. 2, the low-pressure region 28 is semi-annular in shape and extends angularly through about three-quarters of a circle. The low-pressure region 28 is located opposite the pockets 110 formed on the front side 102 of the disc 100 and is proximate the perimeter of the disc 100. The low-pressure region 28 can be any shape and can be arranged at any location on the back side 104 of the seed metering disc 100, depending on the desired location of the pockets 110 on the front side 102 of the disc 100.

A cross-section of one of the seed pockets 110 is shown in FIG. 4. The vacuum openings 120 are spaced apart by a spacing 122 to ensure that each opening 120 has enough room to hold a single seed 12. Some seeds that have a more oblong shape may be held by more than one opening 120. The width, depth, and shape of each seed pocket 110, and the size, shape, spacing, and number of vacuum openings 120 in each pocket are selected to accommodate a range of seeds having different shapes and sizes.

The vacuum openings 120 can have a diameter of between about 0.001 inches and about 0.500 inches.

When a pocket 110 moves into the low-pressure region 28 a pressure differential is created across the vacuum openings 120. A retention force in each hole is defined as the pressure difference from the front side 102 to the back side 104 of the disc 100 multiplied by the area of a particular vacuum hole 120. Seeds 12 are held against the openings 120 in the pockets 110 by the retention force. The diameter of the openings 120 and a spacing 122 between the openings 120 can be different in different embodiments of the seed metering disc 100 to increase or decrease the retention force holding seeds 12 in the pockets 110. When a pocket 110 holding seeds 12 moves out of the low-pressure region 28 the pressure equalizes across the openings 120 and the retention force goes to zero, thereby releasing the seeds 12.

During operation of the seed meter 10, seeds 12 enter the meter 100 through an inlet opening (not shown) in the housing 20 and encounter the front side 102 of the rotating seed metering disc 100. Seeds 12 are collected by the pockets 110 in the front side 102 of the disc 100 as they move through the accumulated seeds 12 at the inlet. Brushes (not shown) attached to the housing 20 help to gather the seeds 12 into the pockets 110 in the front side 102 of the disc 100. As pockets 110 in the rotating disc 100 move across the pickup location 32 and into low pressure region 28 seeds 12 are retained against the vacuum openings 120 by the retention force in each opening 120. Additional brushes (not shown) attached to the housing 20 remove seeds 12 from the pockets 110 that have not been captured by the retention force to prevent extra seeds from being distributed by the seed meter 100.

Captured seeds 12 travel around the seed meter 10 in the pockets 110 and are held in place by the retention force described above. As the pockets 110 cross the release location 34 and leave the low-pressure region 28, the retention force goes to zero and the seeds 12 are released. Released seeds 12′ fall downward through the seed chute 22 through the outlet opening 24 and onto the ground at the desired planting location. When falling, the seeds follow a substantially downward trajectory 38. The trajectory 38 of the released seeds can be altered based on the location and timing of the release of the seeds from the pocket. An optional brush or ejector wheel (not shown) may then be used to clean out any debris from the holes before new seeds are picked up for distribution.

The seed metering discs 100 disclosed herein can have an outer diameter ranging from about 6 inches to about 12 inches, or about 8 inches to about 10 inches. The seed metering discs 100 can have a thickness ranging from about ⅛ of an inch to about ⅝ of an inch, or about 3/16 of an inch, or about ¼ of an inch. The seed metering discs 100 can be made from any suitable material, such as a metal or plastic material, and be made by any suitable means, such as machining, 3D printing, injection molding, casting, or the like.

The pockets 110 can have a diameter ranging from about ½ of an inch to about 3 of an inches and the pockets 110 can all be the same size, as shown in FIGS. 1-3, or can vary in size. The seed metering disc 100 can have any number of pockets 110, such as, for example, as few as 4 pockets 110 and up to as many as 40 pockets 110, or 12 pockets as shown in FIGS. 1-3. The pockets 110 can have a depth ranging from about 1/16 of an inch to about ¼ of an inch, or about ⅛ of an inch, or about 3/16 of an inch.

The vacuum openings 120 can have a diameter (for circular openings) or minor axis (for oval or elliptical shaped openings) ranging from about 1/64 of an inch to about 5/64 of an inch, or about 1/32 of an inch, or about 1/16 of an inch, or about 3/64 of an inch. Each pocket 110 can have any number of openings 120, such as, for example, as few as 10 openings 120 and up to as many as 50 openings 120. The openings 120 can be arranged in rows within the pockets 110 that are spaced apart by about 1/16 of an inch to about 3/16 of an inch, or about ⅛ of an inch.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A seed metering system comprising:
a seed meter; and
a metering disc having:
a front side and a back side;
a plurality of circular pockets in the front side; and
a plurality of openings in each of the circular pockets, the openings being in fluid communication with the back side and arranged in a staggered pattern of rows such that openings in adjacent rows are not aligned;
a low-pressure region in fluid communication with the back side of the metering disc;
wherein the pockets are configured to receive at least two different seed types.

2. The seed metering system of claim 1, wherein the disc can be used with seeds selected from the group of: corn, rye, cereal rye, tie grass, mil, wheat, oats, canola, flax, and cow peas.

3. The seed metering system of claim 1, wherein the pockets are configured to receive at least two different see types at the same time.

4. The seed metering system of claim 1, wherein at least two openings comprise openings of at least two different sizes.

5. A seed metering disc comprising:
a front side and a back side;
a plurality of circular pockets in the front side; and
a plurality of openings in each of the circular pockets, the openings being in fluid communication with the back side and arranged in a staggered pattern of rows such that openings in adjacent rows are not aligned;
wherein the pockets are configured to receive at least two different seed types.

6. The seed metering disc of claim 5, wherein the disc can be used with seeds selected from the group of: corn, rye, cereal rye, tie grass, mil, wheat, oats, canola, flax, and cow peas.

7. The seed metering disc of claim 5, wherein the pockets are configured to receive at least two different seed types at the same time.

8. The seed metering disc of claim 5, wherein the at least two openings comprise openings of at least two different sizes.

9. A seed metering system comprising:
a metering disc having:
a front side and a back side;
a plurality of circular pockets in the front side; and
a plurality of openings in each of the circular pockets, the openings being in fluid communication with the back side and arranged in a staggered pattern of rows such that openings in adjacent rows are not aligned;
a low-pressure region in fluid communication with the back side of the metering disc;
wherein the pockets are configured to receive at least two different seed types.

10. The seed metering system of claim 9, wherein the plurality of openings in each pocket includes at least ten openings.

11. The seed metering system of claim 9, wherein the plurality of openings in each pocket includes at least twenty openings.

12. The seed metering system of claim 9 wherein the plurality of openings in each pocket includes at least thirty openings.

13. The seed metering system of claim 9, wherein the pockets are configured to receive at least two different seed types at the same time.

14. The seed metering system of claim 9, wherein the plurality of openings comprise openings of at least two different sizes.
